(19) United States
(12) Patent Application Publication
(10) Pub. No.: US 2022/0335449 A1
(43) Pub. Date: Oct. 20, 2022

(54) INFORMATION MANAGEMENT SYSTEM

(71) Applicant: Honda Motor Co., Ltd., Tokyo (JP)

(72) Inventor: Daisuke SAKAMOTO, Tokyo (JP)

(73) Assignee: Honda Motor Co., Ltd., Tokyo (JP)

(21) Appl. No.: 17/680,329

(22) Filed: Feb. 25, 2022

(30) Foreign Application Priority Data
Mar. 9, 2021 (JP) 2021-037111

(51) Int. Cl. G06Q 30/02

(52) U.S. Cl. CPC G06Q 30/0201; G06Q 30/0206; G06Q 30/0276

(57) ABSTRACT

An information management system is provided. By performing designated filter processes on data collected via a network, a post number set, an estimation number set, and a sales number set are acquired for each type of product handled by a designated entity. By combining the post number set, the estimation number set, and the sales number set based on a unified notation common to each set, combined data in which a post number, an estimation number, and a sales number are associated for each type of product is generated. Correlation information indicating correlations between the post number, the estimation number, and the sales number is generated for each type of product based on the combined data and is outputted to an output interface of an information terminal device.

### CROSS-REFERENCE TO RELATED APPLICATION

This application claims the priority benefit of Taiwan application serial no. 2021-037111, filed on Mar. 9, 2021. The entirety of the above-mentioned patent application is hereby incorporated by reference herein and made a part of this specification.

### BACKGROUND

### Technical Field

The disclosure relates to a system which searches information from a database.

### Description of Related Art

A technical method has been proposed for objectively predicting a sale price and the like of an article before resale based on a sale data of an article such as a vehicle that has already been sold (see, for example, Patent Document 1: Japanese Patent Application Laid-Open No. 2010-231826). A technical method has been proposed to record a vehicle chart that records useful information when assessing the price of an automobile (see, for example, Patent Document 2: Japanese Patent Application Laid-Open No. 2010-009572). In a used car brokerage system which has been proposed, the seller can sell safely and the buyer's cost can be suppressed (see, for example, Patent Document 3: Japanese Patent Application Laid-Open No. 2015-085320). A technical method has been proposed for selling automobile insurance to customers at an appropriate timing and improving the contract rate, considering each stage of automobile sales (appropriate stage, not early stage) (see, for example, Patent Document 4: Japanese Patent Application Laid-Open No. 2019-175119).

However, a method of using data related to various products existing in the network for analysis of sales strategies and/or advertisement strategies of the product has not been established.

### SUMMARY

An information management system of an embodiment of the disclosure includes a first information processing element and a second information processing element. By performing designated filter processes on data collected via a network, the first information processing element acquires, for each of types of products handled by a designated entity, a post number set which is a set of post numbers of texts associated with a unified notation and arbitrary notations of the product, an estimation number set which is a set of estimation numbers associated with the unified notation and arbitrary notations of the product, and a sales number set which is a set of sales numbers associated with the unified notation and arbitrary notations of the product, respectively, and by combining the post number set, the estimation number set, and the sales number set based on the unified notation, the first information processing element generates combined data in which the post number, the estimation number, and the sales number are associated for each of the types of the products. The second information processing element generates correlation information indicating correlations between the post number, the estimation number, and the sales number for each of the types of the products based on the combined data, and outputs the correlation information to an output interface.

According to the information management system of the configuration, by performing designated filter processes on the data collected via the network, the “post number set”, the “estimation number set”, and the “sales number set” are acquired for each type of product handled by the designated entity. “Entity” is a concept including a juridical person, or an organization that does not have juridical personality, and/or an individual. “Product” is a concept including goods and/or services. Furthermore, by combining the post number set, the estimation number set, and the sales number set based on the unified notation common to each set, combined data in which the “post number”, the “estimation number”, and the “sales number” are associated for each type of product is generated. Then, based on the combined data, correlation information indicating correlations between the post number, the estimation number, and the sales number is generated for each type of product and is outputted to the output interface.

Accordingly, it is possible to enable the user in contact with the output interface to learn about the correlations between the post number, the estimation number, and the sales number in a designated period with respect to a plurality of types of products and use them for analysis of sales strategies and/or advertisement strategies of each type of product.

### BRIEF DESCRIPTION OF THE DRAWINGS

FIG. 1 is a view showing a configuration of an information management system as an embodiment of the disclosure.

FIG. 2 is a flowchart of a data integration method.

FIG. 3 is a view showing the data integration method.

FIG. 4A is a view showing a first output mode of integrated data.

FIG. 4B is view showing a second output mode of integrated data.

### DESCRIPTION OF THE EMBODIMENTS

An embodiment of the disclosure provides a system capable of improving usefulness of various data related to various products existing in a network for analyzing sales strategies and/or advertisement strategies of the product. Hereinafter, the embodiment of the disclosure will be described with reference to the drawings.

(Configuration)

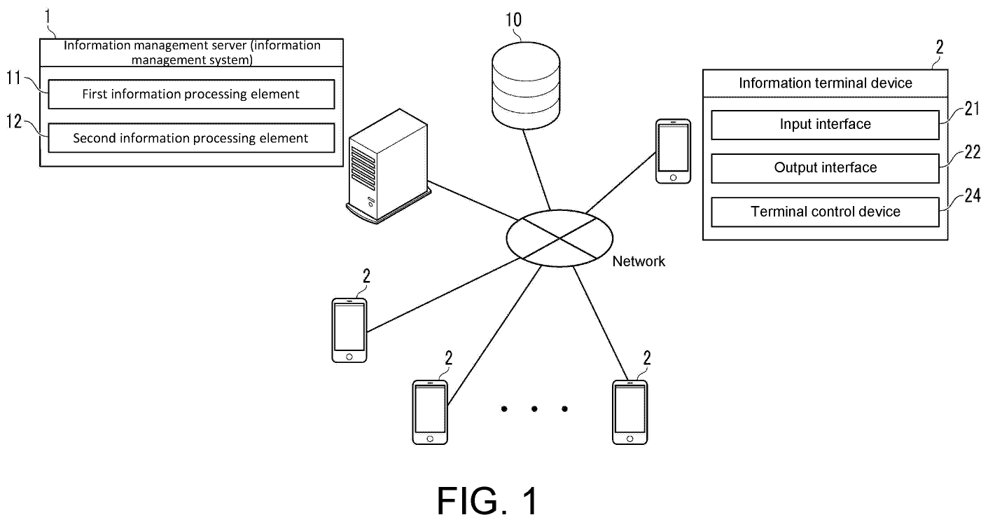

An information management system as an embodiment of the disclosure as shown in FIG. 1 is configured by an information management server 1 capable of communicating with an information terminal device 2 and a database server 10 via a network. The database server 10 may also be a component of the information management server 1.

The information management server 1 includes a first information processing element 11 and a second information processing element 12. Each of the elements 11 and 12 is configured by an arithmetic processing device (configured by hardware such as a CPU, a single-core processor, and/or a multi-core processor) which reads necessary data and program (software) from a storage device (configured by a memory such as a ROM, a RAM, and an EEPROM, or hardware such as an SSD and an HDD), and then executes arithmetic processing on the data according to the program.

The information terminal device 2 is configured by a portable terminal device such as a smartphone, a tablet terminal device, and/or a notebook computer, and may also be configured by a stationary terminal device such as a desktop computer. The information terminal device 2 includes an input interface 21, an output interface 22, and a terminal control device 24. The input interface 21 may be configured by, for example, a touch panel-type button and a voice recognition device having a microphone. The output interface 22 may be configured by, for example, a display device constituting a touch panel and an audio output device. The terminal control device 24 is configured by an arithmetic processing device (configured by hardware such as a CPU, a single-core processor, and/or a multi-core processor) which reads necessary data and program (software) from a storage device (configured by a memory such as a ROM, a RAM, and an EEPROM, or hardware such as an SSD and an HDD), and then executes arithmetic processing on the data according to the program.

(Function)

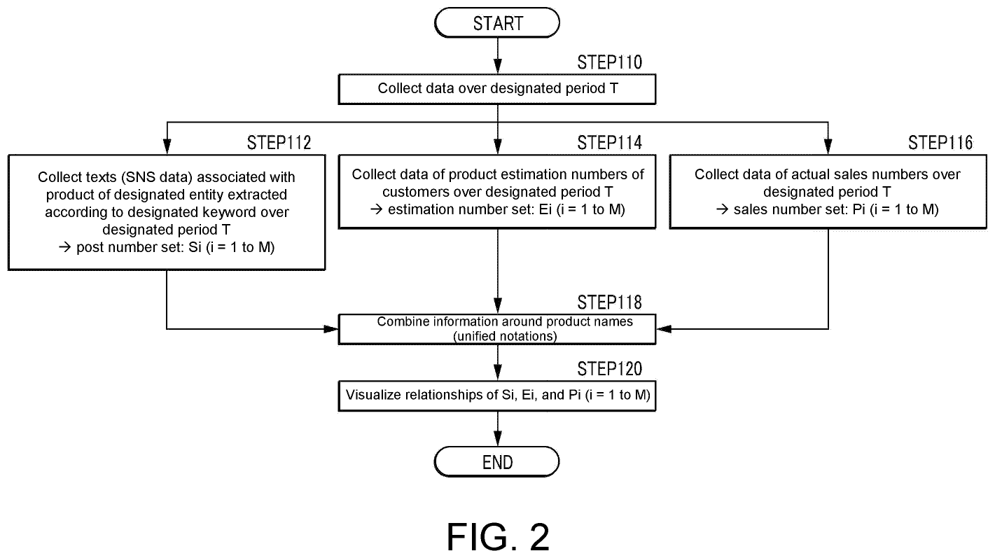

The function of the information management system having the above configuration will be described with reference to the flowchart of FIG. 2. A series of processes related to the function may be repeatedly executed periodically for each designated period.

The first information processing element 11 collects data over a designated period through the network (FIG. 2/STEP110). “Data” includes text data acquired via the network from designated media such as mass media (e.g., TV, radio, and newspapers), network media (e.g., electronic bulletin boards, blogs, and social networking services (SNS)), and multimedia. In addition, “data” includes text data and numerical data acquired via the network from the information terminal device 2 of a product or a trader or an entity that handles the product. Each data is attached with a time stamp indicating a characteristic time point, such as a time point when the data is posted, a time point when the data is published, and/or a time point when the data is edited.

Next, with the first information processing element 11 performing a first designated filter process on the collected data over the designated period T according to a designated keyword indicating an automobile manufacturer and a type of automobile, texts (e.g., SNS data) related to the automobile which is a product of the automobile manufacturer are collected. As a result, a post number set {S|Si (i=1 to M)} of the texts related to each of M types of automobiles is generated (FIG. 2/STEP112). The designated keyword is designated or inputted by the user through the input interface 21 of the information terminal device 2 and is acquired based on network communication with the information terminal device 2.

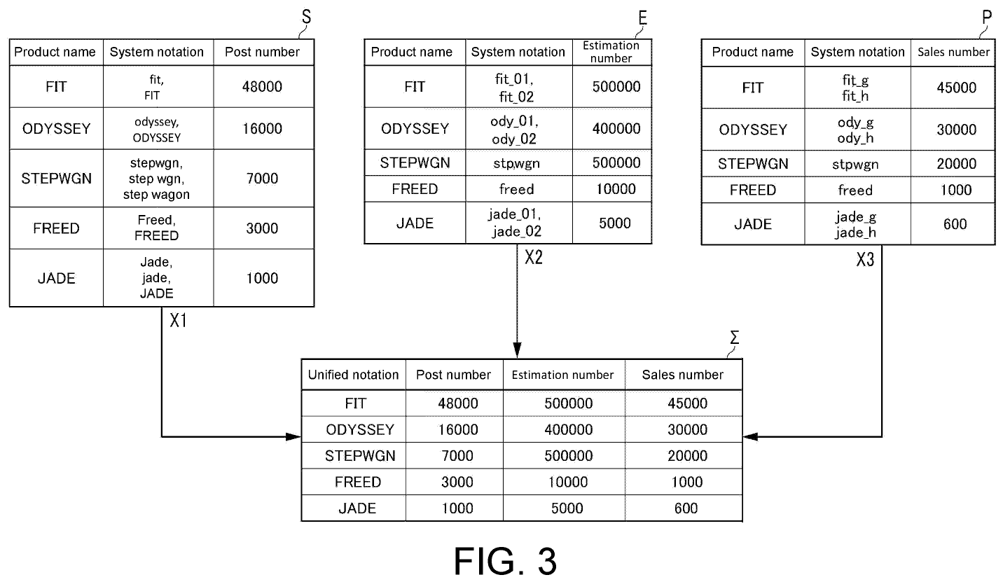

Accordingly, for example, as shown in FIG. 3, a set of a post number Si associated with a product name and a notation with respect to an i^{th} type of product is generated as a post number set S. Since the expression of a same type of product generally differs depending on the creator/poster of the text, there may be a plurality of different notations with respect to a same type of product name.

For example, as shown in FIG. 3, a single product name “FIT” and a plurality of notations “fit” and “FIT” are associated with a post number S1=48000 related to a 1^{st} type of product (i=1). A single product name “ODYSSEY” and a plurality of notations “odyssey” and “ODYSSEY” are associated with a post number S2=16000 related to a 2^{nd} type of product (i=2). A single product name “STEPWGN” and a plurality of notations “stepwgn”, “step wgn”, and “step wagon” are associated with a post number S3=7000 related to a 3^{rd} type of product (i=3). A single product name “FREED” and a plurality of notations “Freed” and “FREED” are associated with a post number S4=3000 related to a 4^{th} type of product (i=4). A single product name “JADE” and a plurality of notations “Jade”, “jade”, and “JADE” are associated with a post number S5=1000 related to a 5^{th} type of product (i=5).

With the first information processing element 11 performing a second designated filter process on the collected data over the designated period T according to the keyword indicating the automobile manufacturer and the type of automobile, data related to cost estimates of the automobile which is a product of the automobile manufacturer are collected. Then, an estimation number set {E|Ei (i=1 to M)} related to each of M types of automobiles is generated (FIG. 2/STEP114).

Accordingly, for example, as shown in FIG. 3, a set of an estimation number Ei associated with a product name and a notation with respect to an i^{th} type of product is generated as an estimation number set E. Even if it is the same type of product, due to different grades, configurations, and/or specifications of the product subjected to cost estimation, there may be a plurality of different notations with respect to a same type of product name.

For example, in the estimation number set E shown in FIG. 3, a single product name “FIT” and a plurality of notations “fit_01” and “fit_02” are associated with an estimation number E1=500000 related to a 1^{st} type of product (i=1). A single product name “ODYSSEY” and a plurality of notations “ody_01” and “ody_02” are associated with an estimation number E2=400000 related to a 2^{nd} type of product (i=2). A single product name “STEPWGN” and one notation “stpwgn” are associated with an estimation number E3=500000 related to a 3^{rd} type of product (i=3). A single product name “FREED” and one notation “freed” are associated with an estimation number E4=10000 related to a 4^{th} type of product (i=4). A single product name “JADE” and a plurality of notations “jade_01” and “jade_02” are associated with an estimation number E5=5000 related to a 5^{th} type of product (i=5).

With the first information processing element 11 performing a third designated filter process on the collected data over the designated period T according to the keyword indicating the automobile manufacturer and the type of automobile, sales numbers related to the automobile which is a product of the automobile manufacturer are collected. Then, a sales number set {P|Pi (i=1 to M)} related to each of M types of automobiles is generated (FIG. 2/STEP116).

Accordingly, for example, as shown in FIG. 3, a set of a sales number Pi associated with a product name and a notation with respect to an i^{th} type of product is generated as a sales number set P. Even if it is the same type of product, due to different grades, configurations, and/or specifications of the product subjected to cost estimation, there may be a plurality of different notations with respect to a same type of product name.

For example, in the sales number set P shown in FIG. 3, a single product name “FIT” and a plurality of notations “fit_g” and “fit_h” are associated with a sales number P1=45000 related to a 1^{st} type of product (i=1). A single product name “ODYSSEY” and a plurality of notations “ody_g” and “ody_h” are associated with a sales number P2=30000 related to a 2^{nd} type of product (i=2). A single product name “STEPWGN” and one notation “stpwgn” are associated with a sales number P3=20000 related to a 3^{rd} type of product (i=3). A single product name “FREED” and one notation “freed” are associated with a sales number P4=1000 related to a 4^{th} type of product (i=4). A single product name “JADE” and a plurality of notations “jade_g” and “jade_h” are associated with a sales number P5=600 related to a 5^{th} type of product (i=5).

Then, with the first information processing element 11 combining the post number set S, the estimation number set E, and the sales number set P based on the product name (unified notation), combined data Σ is generated (FIG. 2/STEP118).

Accordingly, for example, as shown in FIG. 3, the combined data Σ is generated with the combination of the product name (unified notation), the post number Si, the estimation number Ei, and the sales number Pi taken as a component Σi with respect to the i^{th} type of product (see FIG. 3/arrows X1 to X3). At this time, the variation in notation with respect to a same type of product is eliminated.

Next, the second information processing element 12 generates correlation information indicating correlations between the post number Si, the estimation number Ei, and the sales number Pi with respect to the i^{th} type of product based on the combined data and transmits the correlation information to the information terminal device 2 via the network, and the correlation information is outputted to the output interface of the information terminal device 2 accordingly (FIG. 2/STEP120).

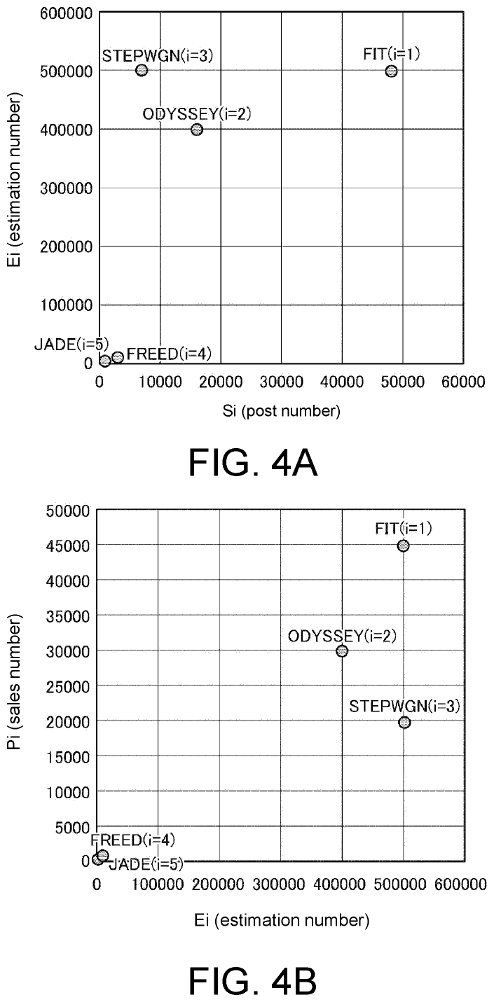

Accordingly, for example, as shown in FIG. 4A, the correlation information indicating the correlation between the post number Si and the estimation number Ei with respect to each type of product is outputted to the output interface 22 of the information terminal device 2. Further, as shown in FIG. 4B, the correlation information indicating the correlation between the estimation number Ei and the sales number Pi with respect to each type of product is outputted to the output interface 22 of the information terminal device 2. The screens of FIG. 4A and FIG. 4B may be outputted to the output interface 22 at the same time, or may also be switched and outputted according to an operation through the input interface 21.

(Action and Effect)

According to the information management system 1 having the above configuration, by performing designated filter processes on the data collected via the network, the post number set S, the estimation number set E, and the sales number set P are acquired for each type of product handled by the designated entity (see FIG. 2/STEP112, STEP114, and STEP116). By combining the post number set S, the estimation number set E, and the sales number set P based on the unified notation common to each set, the combined data Σ in which the post number Si, the estimation number Ei, and the sales number Pi are associated for each type of product is generated (see FIG. 2/STEP118 and FIG. 3/arrows X1 to X3). Then, based on the combined data, correlation information indicating the correlations between the post number Si, the estimation number Ei, and the sales number Pi with respect to each type of product are generated and are outputted to the output interface 22 of the information terminal device 2 (see FIG. 2/STEP120, FIG. 4A, and FIG. 4B).

Accordingly, it is possible to enable a user in contact with the output interface 22 of the information terminal device 2 to learn about the correlations between the post number, the estimation number, and the sales number over a designated period with respect to a plurality of types of products and use them for analysis of sales strategies and/or advertisement strategies of each type of product.

For example, as shown in FIG. 4A, it is learned that while the post number S3 related to STEPWGN (third type of product) is relatively small, the estimation number E3 is relatively large. In other words, although STEPWGN is not much talked about in communities connected via the SNS or the network, consumers are highly interested in the product. Therefore, it is possible for the user to infer that a campaign conducted for STEPWGN may be contributing to the increase in the estimation number. Further, as shown in FIG. 4A, while the post number S1 related to FIT (first type of product) is relatively large, the estimation number E1 is relatively small; therefore, it is learned that the estimation number has not increased even though the product has a sufficiently large topicality on the SNS and the like. Therefore, the user may suppose that further advertisement for FIT would not be of much use.

Further, as shown in FIG. 4B, it is learned that while the estimation number E3 related to STEPWGN (third type of product) is relatively large, the sales number P3 is considerably smaller than the sales number P1 of FIT (first type of product). Therefore, for example, the user may suppose that prospective customers of STEPWGN are leaking to a competitor's product, or STEPWGN may be a purchase candidate but the customers eventually change to FIT at the store.

What is claimed is:

1. An information management system comprising:
a first information processing element, wherein by performing designated filter processes on data collected via a network, the first information processing element acquires, for each of types of products handled by a designated entity, a post number set which is a set of post numbers of texts associated with a unified notation and arbitrary notations of the product, an estimation number set which is a set of estimation numbers associated with the unified notation and arbitrary notations of the product, and a sales number set which is a set of sales numbers associated with the unified notation and arbitrary notations of the product, respectively, and by combining the post number set, the estimation number set, and the sales number set based on the unified notation, the first information processing element generates combined data in which the post number, the estimation number, and the sales number are associated for each of the types of the products; and
a second information processing element which generates correlation information indicating correlations between the post number, the estimation number, and the sales number for each of the types of the products based on the combined data, and outputs the correlation information to an output interface.
